(19) United States
(12) Patent Application Publication
(10) Pub. No.: US 2023/0373503 A1
(43) Pub. Date: Nov. 23, 2023

(54) VEHICLE CONTROLLER, METHOD AND COMPUTER PROGRAM FOR VEHICLE CONTROL, PRIORITY SETTING DEVICE, AND VEHICLE CONTROL SYSTEM

(71) Applicant: TOYOTA JIDOSHA KABUSHIKI KAISHA, Toyota-shi (JP)

(72) Inventor: Koshiro HASHIMOTO, Tokyo-to (JP)

(73) Assignee: TOYOTA JIDOSHA KABUSHIKI KAISHA, Toyota-shi (JP)

(21) Appl. No.: 18/190,367

(22) Filed: Mar. 27, 2023

(30) Foreign Application Priority Data
May 17, 2022 (JP) 2022-081032

(51) Int. Cl. B60W 50/06

(52) U.S. Cl. CPC B60W 50/06; B60W 2050/0026

(57) ABSTRACT

A vehicle controller includes a memory configured to store a priority table representing degrees of priority of a plurality of processes related to automatically driving or assisting in driving a vehicle for each road section or for each possible situation around the vehicle; and a processor configured to determine a road section where the vehicle is or the situation around the vehicle according to the position of the vehicle or a sensor signal generated by a sensor mounted on the vehicle for detecting the situation around the vehicle, determine degrees of priority of the processes, depending on the road section where the vehicle is or the situation around the vehicle, by referring to the priority table, and execute the processes sequentially in descending order of priority of the processes, using a shared resource.

### FIELD

The present invention relates to a vehicle controller, a method and a computer program for vehicle control, a priority setting device, and a vehicle control system.

### BACKGROUND

In autonomous driving control of a vehicle or assistance in driving a vehicle, different processes should be applied depending on the position of the vehicle in some cases. Thus, a technique that enables autonomous driving control depending on the current position of a vehicle has been proposed (see International Publication WO2017/051478A).

An automatic driving device disclosed in WO2017/051478A refers to map data including driving automation levels that are levels of automation of automatic driving control associated with predetermined sections of roads. Based on the map data and the current position of a host vehicle, the automatic driving device generates guidance information on automatic driving control depending on the driving automation level in the current position of the vehicle and an area ahead thereof.

### SUMMARY

In some cases, multiple processes are executed for automatically driving or assisting in driving a vehicle. In such cases, it is desirable to execute these processes appropriately, depending on a road section where the vehicle is or the situation around the vehicle, in order not to hinder autonomous driving or driving assistance.

It is an object of the present invention to provide a vehicle controller that can execute a process having high priority in a road section where the vehicle is or the situation around the vehicle without delay.

According to an embodiment, a vehicle controller is provided. The vehicle controller includes: a memory configured to store a priority table representing degrees of priority of a plurality of processes related to automatically driving or assisting in driving a vehicle for each road section or for each possible situation around the vehicle; and a processor configured to: determine a road section where the vehicle is or the situation around the vehicle according to the position of the vehicle or a sensor signal generated by a sensor mounted on the vehicle for detecting the situation around the vehicle, determine degrees of priority of the processes, depending on the road section where the vehicle is or the situation around the vehicle, by referring to the priority table, and execute the processes sequentially in descending order of priority of the processes, using a shared resource.

According to another embodiment of the present invention, a method for vehicle control is provided. The method includes: determining a road section where a vehicle is or the situation around the vehicle according to the position of the vehicle or a sensor signal generated by a sensor mounted on the vehicle for detecting the situation around the vehicle; determining degrees of priority of a plurality of processes related to automatically driving or assisting in driving the vehicle, depending on the road section where the vehicle is or the situation around the vehicle, by referring to a priority table representing degrees of priority of the processes for each road section or for each possible situation around the vehicle; and executing the processes sequentially in descending order of priority of the processes, using a shared resource.

According to another embodiment of the present invention, a non-transitory recording medium that stores a computer program for vehicle control is provided. The computer program includes instructions causing a processor mounted on a vehicle to execute a process including: determining a road section where the vehicle is or the situation around the vehicle according to the position of the vehicle or a sensor signal generated by a sensor mounted on the vehicle for detecting the situation around the vehicle; determining degrees of priority of a plurality of processes related to automatically driving or assisting in driving the vehicle, depending on the road section where the vehicle is or the situation around the vehicle, by referring to a priority table representing degrees of priority of the processes for each road section or for each possible situation around the vehicle; and executing the processes sequentially in descending order of priority of the processes, using a shared resource.

According to still another embodiment of the present invention, a priority setting device is provided. The priority setting device includes a memory; and a processor configured to: store, every time execution information is received from at least one vehicle via a communication module, the received execution information in the memory, the execution information indicating a road section traveled by the vehicle or the situation around the vehicle at execution of a process among a plurality of processes related to automatically driving or assisting in driving the vehicle as well as the executed process, set degrees of priority of the processes for each road section or for each possible situation around the vehicle, based on pieces of execution information stored in the memory, so that a process executed a larger number of times has higher priority among the processes, and notify the vehicle via the communication module of a priority table representing degrees of priority of the processes for each road section or for each possible situation around the vehicle.

According to yet another embodiment of the present invention, a vehicle control system including at least one vehicle and a priority setting device capable of communicating with the at least one vehicle is provided. In the vehicle control system, each of the at least one vehicle includes a memory configured to store a priority table representing degrees of a plurality of priority of processes related to automatically driving or assisting in driving the vehicle for each road section or for each possible situation around the vehicle; and a processor configured to: determine a road section where the vehicle is or the situation around the vehicle according to the position of the vehicle or a sensor signal generated by a sensor mounted on the vehicle for detecting the situation around the vehicle, determine degrees of priority of the processes, depending on the road section where the vehicle is or the situation around the vehicle, by referring to the priority table, execute the processes sequentially in descending order of priority of the processes, using a shared resource, generate execution information indicating a process actually reflected in an action of the vehicle among the processes as well as the road section where the vehicle is or the situation around the vehicle, and transmit the generated execution information to the priority setting device via a communication device. The priority setting device includes: a memory; and a processor configured to: store, every time the execution information is received from one of the at least one vehicle via a communication module, the execution information in the memory of the priority setting device, set degrees of priority of the processes for each road section or for each possible situation around the at least one vehicle, based on pieces of execution information stored in the memory of the priority setting device, so that a process executed a larger number of times has higher priority among the processes, and notify each of the at least one vehicle via the communication module of the priority table representing degrees of priority of the processes for each road section or for each possible situation around the vehicle.

The vehicle controller according to the present invention has an advantageous effect of being able to execute a process having high priority in a road section where the vehicle is or the situation around the vehicle without delay.

### BRIEF DESCRIPTION OF DRAWINGS

FIG. 1 schematically illustrates the configuration of a vehicle control system equipped with a vehicle controller and a priority setting device.

FIG. 2 schematically illustrates the configuration of a vehicle.

FIG. 3 illustrates the hardware configuration of an electronic control unit, which is an embodiment of the vehicle controller.

FIG. 4 is a functional block diagram of a processor of the electronic control unit, related to a vehicle control process.

FIG. 5 is a schematic diagram for explaining setting of degrees of priority.

FIG. 6 is an operation flowchart of the vehicle control process.

FIG. 7 illustrates the hardware configuration of a server, which is an example of the priority setting device.

FIG. 8 is a functional block diagram of a processor of the server, related to a priority setting process.

FIG. 9 is an operation flowchart of the priority setting process.

### DESCRIPTION OF EMBODIMENTS

A vehicle controller, a method and a computer program for vehicle control executed by the vehicle controller, a priority setting device, and a vehicle control system including the vehicle controller and the priority setting device will now be described with reference to the attached drawings. The vehicle controller is mounted on a vehicle, and generates execution information upon execution of a process among a plurality of processes related to automatically driving or assisting in driving the vehicle. The execution information indicates the executed process as well as a road section traveled by the vehicle or the situation around the vehicle at execution of the process. The vehicle controller transmits the generated execution information to the priority setting device. The priority setting device sets degrees of priority of the processes for each road section or for each situation around the vehicle, based on received pieces of execution information, so that a process executed a larger number of times has higher priority. The priority setting device then delivers a priority table representing degrees of priority of the processes set for each road section or for each possible situation around the vehicle to the vehicle.

In addition, the vehicle controller refers to the priority table representing degrees of priority of processes related to automatically driving or assisting in driving the vehicle for each road section or for each possible situation around the vehicle, at executing autonomous driving control of the vehicle or assisting the driver in driving. The vehicle controller then determines degrees of priority of the processes, depending on the road section where the vehicle is or the situation around the vehicle, and executes the processes sequentially in descending order of priority, using a shared resource.

The processes related to automatically driving or assisting in driving the vehicle include a lane change-related process, a speed control-related process, such as adaptive cruise control (ACC), and a collision avoidance-related process. These processes may further include a process related to determination of the driver's state and a process related to collection of data of the surroundings of the vehicle (hereafter a “data collection-related process”). The processes related to automatically driving or assisting in driving the vehicle may include a process other than the processes mentioned above. In the following, the processes related to automatically driving or assisting in driving the vehicle will be referred to simply as the “processes.”

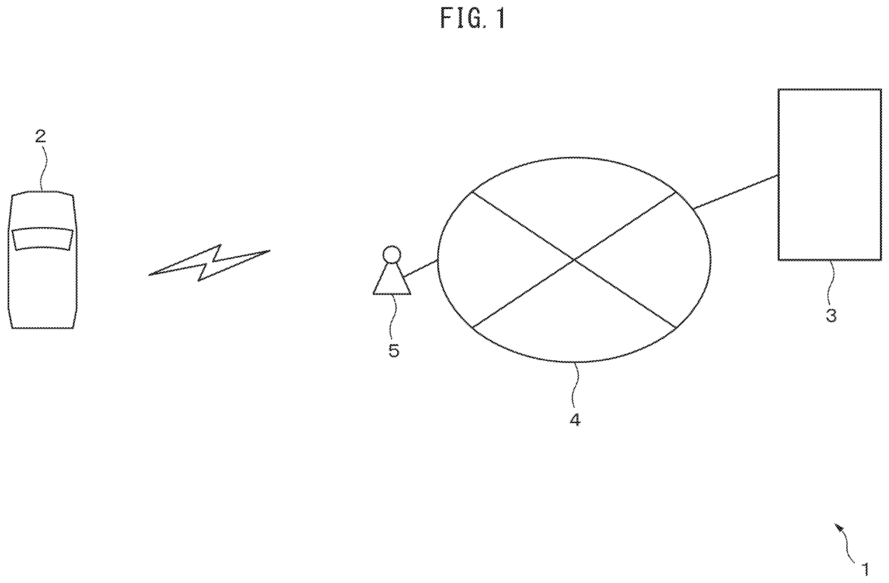

FIG. 1 schematically illustrates the configuration of a vehicle control system equipped with the vehicle controller and the priority setting device. In the present embodiment, the vehicle control system 1 includes at least one vehicle 2 and a server 3, which is an example of the priority setting device. Each vehicle 2 accesses a wireless base station 5, which is connected, for example, via a gateway (not illustrated) to a communication network 4 connected with the server 3, thereby connecting to the server 3 via the wireless base station 5 and the communication network 4. For simplicity, FIG. 1 illustrates only a single vehicle 2, but the vehicle control system 1 may include multiple vehicles 2. FIG. 1 also illustrates only a single wireless base station 5, but the communication network 4 may be connected with multiple wireless base stations 5.

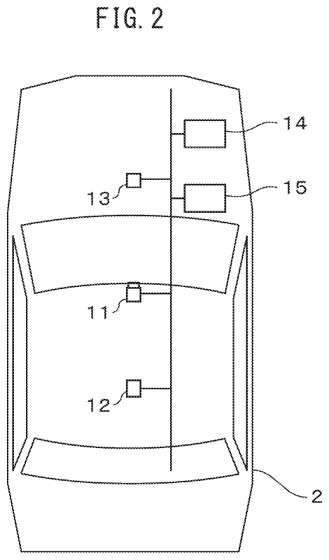

FIG. 2 schematically illustrates the configuration of the vehicle 2. The vehicle 2 includes a camera 11, a GPS receiver 12, a wireless communication terminal 13, a storage device 14, and an electronic control unit (ECU) 15, which is an example of the vehicle controller. The camera 11, the GPS receiver 12, the wireless communication terminal 13, and the storage device 14 are communicably connected to the ECU 15 via an in-vehicle network conforming to a standard such as a controller area network. The vehicle 2 may further include a navigation device (not illustrated) that searches for a planned travel route of the vehicle 2 and that navigates so that the vehicle 2 travels along the planned travel route. The vehicle 2 may further include a distance sensor (not illustrated), such as LiDAR or radar, which measures the distances from the vehicle 2 to objects around the vehicle 2; and a driver monitoring camera (not illustrated) provided so as to take pictures of the driver.

The camera 11, which is an example of a sensor for detecting the situation around the vehicle 2, includes a two-dimensional detector constructed from an array of optoelectronic transducers, such as CCD or C-MOS, having sensitivity to visible light and a focusing optical system that forms an image of a target region on the two-dimensional detector. The camera 11 is mounted, for example, in the interior of the vehicle 2 so as to be oriented, for example, to the front of the vehicle. The camera 11 takes pictures of a region in front of the vehicle 2 every predetermined capturing period (e.g., 1/30 to 1/10 seconds), and generates images representing the region. Each image obtained by the camera 11 is an example of the sensor signal, and may be a color or grayscale image. The vehicle 2 may include multiple cameras taking pictures in different orientations or having different focal lengths.

Every time an image is generated, the camera 11 outputs the generated image to the ECU 15 via the in-vehicle network.

The GPS receiver 12 receives GPS signals from GPS satellites at predetermined intervals, and determines the position of the vehicle 2, based on the received GPS signals. The predetermined intervals at which the GPS receiver 12 determines the position of the vehicle 2 may differ from the capturing period of the camera 11. The GPS receiver 12 outputs positioning information indicating the result of determination of the position of the vehicle 2 based on the GPS signals to the ECU 15 via the in-vehicle network at predetermined intervals. Instead of the GPS receiver 12, the vehicle 2 may include a receiver conforming to a satellite positioning system other than the GPS receiver 12. In this case, the receiver determines the position of the vehicle 2.

The wireless communication terminal 13, which is an example of the communication unit or a communication device, is a device to execute a wireless communication process conforming to a predetermined standard of wireless communication, and accesses, for example, the wireless base station 5 to connect to the server 3 via the wireless base station 5 and the communication network 4. The wireless communication terminal 13 generates an uplink radio signal including execution information and other information received from the ECU 15, and transmits the uplink radio signal to the wireless base station 5 to transmit the execution information and other information to the server 3. In addition, the wireless communication terminal 13 receives a downlink radio signal from the wireless base station 5, and passes, for example, a priority table from the server 3 included in the radio signal to the ECU 15. The downlink radio signal may include traffic information delivered from a traffic information server (not illustrated) or weather information delivered from a weather information server (not illustrated).

The storage device 14 includes, for example, a hard disk drive, a nonvolatile semiconductor memory, or an optical medium and an access device therefor. The storage device 14 stores a high-precision map, which includes information used for autonomous driving control of the vehicle, e.g., information indicating the number of lanes, road markings such as lane-dividing lines or stop lines, and signposts for each road included in a predetermined region represented in the map. Further, the high-precision map may be associated with a priority table.

The storage device 14 may further include a processor for executing, for example, a process to update the high-precision map and a process related to a request from the ECU 15 to read out the high-precision map. For example, every time the vehicle 2 moves a predetermined distance, the storage device 14 may transmit a request to obtain a high-precision map, together with the current position of the vehicle 2, to a map server via the wireless communication terminal 13. The storage device 14 may receive a high-precision map of a predetermined region around the current position of the vehicle 2 from the map server via the wireless communication terminal 13. Upon receiving a request from the ECU 15 to read out the high-precision map, the storage device 14 cuts out that portion of the high-precision map stored therein which includes the current position of the vehicle 2 and which represents a region smaller than the predetermined region, and outputs the cut portion to the ECU 15 via the in-vehicle network.

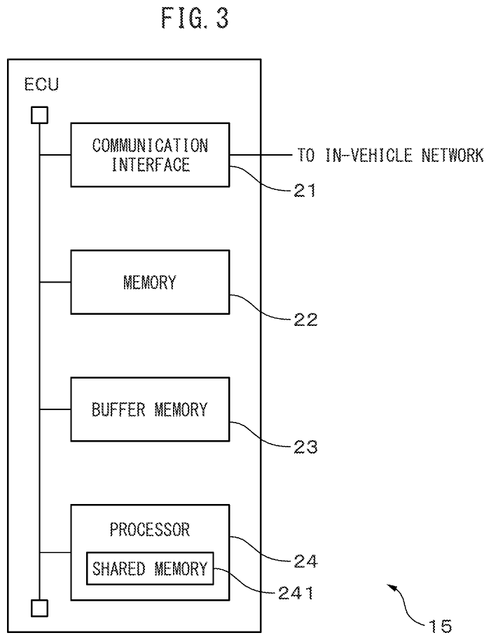

FIG. 3 illustrates the hardware configuration of the ECU 15, which is an embodiment of the vehicle controller. The ECU 15 executes autonomous driving control of the vehicle 2 or assists the driver in driving the vehicle 2. In addition, the ECU 15 generates execution information, based on a process executed at the vehicle 2. To achieve this, the ECU 15 includes a communication interface 21, a memory 22, a buffer memory 23, and a processor 24. The communication interface 21, the memory 22, the buffer memory 23, and the processor 24 may be configured as different circuits or a single integrated circuit.

The communication interface 21 includes an interface circuit for connecting the ECU 15 to the in-vehicle network. In other words, the communication interface 21 is connected to the camera 11 via the in-vehicle network. Every time an image is received from the camera 11, the communication interface 21 passes the received image to the processor 24. Every time positioning information is received from the GPS receiver 12, the communication interface 21 passes the received positioning information to the processor 24. In addition, the communication interface 21 passes the high-precision map read from the storage device 14 to the processor 24. Further, the communication interface 21 passes a priority table and other data received from the wireless communication terminal 13 to the processor 24. Further, the communication interface 21 outputs execution information received from the processor 24 to the wireless communication terminal 13.

The memory 22, which is an example of the storage unit, includes, for example, volatile and nonvolatile semiconductor memories. The memory 22 stores an algorithm for a vehicle control process executed by the processor 24 of the ECU 15 as well as various types of data and various parameters used in the vehicle control process. For example, the memory 22 stores a high-precision map read from the storage device 14, a priority table received from the server 3, and a set of parameters for specifying a classifier used in the vehicle control process. The memory 22 may further store traffic information and weather information. Further, the memory 22 stores various types of data generated during the vehicle control process, such as execution information and information on detected objects, for a certain period.

The buffer memory 23, which is another example of the storage unit, includes, for example, a volatile semiconductor memory. The buffer memory 23 temporarily stores images received from the camera 11 and positioning information received from the GPS receiver 12. The buffer memory 23 may temporarily store driver monitor images received from the driver monitoring camera (not illustrated).

The processor 24 includes, for example, one or more central processing units (CPUs) and a peripheral circuit thereof. The processor 24 may further include an arithmetic circuit or a graphics processing unit (GPU). In addition, the processor 24 includes a shared memory 241, which is an example of the shared resource and is configured, for example, as a memory circuit accessible from the operating circuits or processing circuits included in the processor 24, such as the CPUs and GPU.

Every time an image is received from the camera 11 during travel of the vehicle 2, the processor 24 writes the received image in the buffer memory 23. Similarly, every time positioning information is received from the GPS receiver 12, the processor 24 writes the received positioning information in the buffer memory 23. Further, the processor 24 stores a high-precision map read from the storage device 14, and traffic information and weather information received via the wireless communication terminal 13, in the memory 22. Further, the processor 24 executes the vehicle control process, based on, for example, images stored in the buffer memory 23.

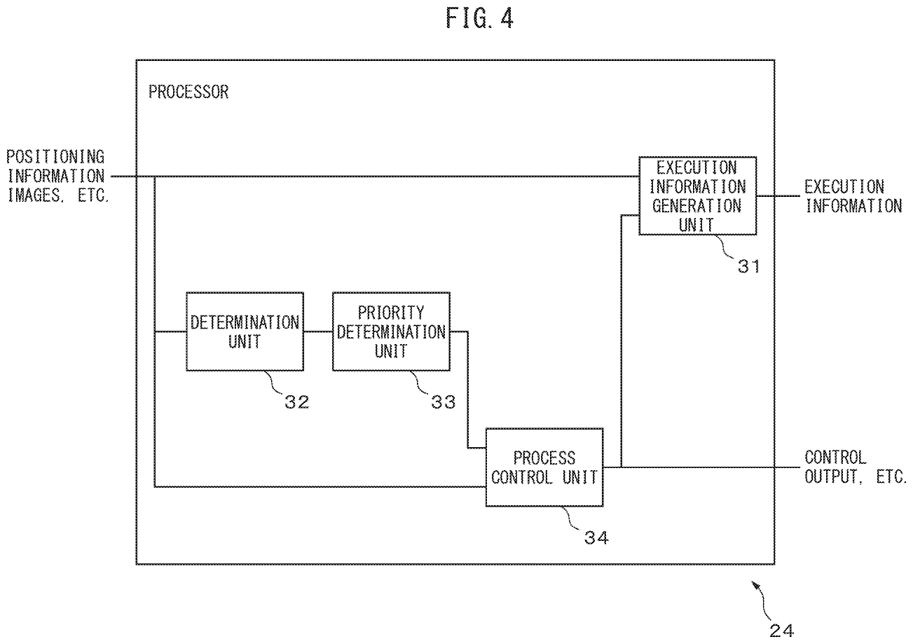

FIG. 4 is a functional block diagram of the processor 24 of the ECU 15, related to the vehicle control process. The processor 24 includes an execution information generation unit 31, a determination unit 32, a priority determination unit 33, and a process control unit 34. These units included in the processor 24 are functional modules, for example, implemented by a computer program executed by the processor 24. Of these units, processing executed by the determination unit 32, the priority determination unit 33, and the process control unit 34 relates to the vehicle control process. Processing executed by the execution information generation unit 31 is to generate information used in a priority setting process executed by the server 3.

Upon execution of one of processes related to automatically driving or assisting in driving the vehicle 2, the execution information generation unit 31 generates execution information on the executed process. For example, when the driver operates a switch (not illustrated) provided in the vehicle interior to turn ACC on, the execution information generation unit 31 generates execution information indicating ACC as the executed process. Additionally, upon receiving notification indicating execution of a predetermined process from the process control unit 34 during application of autonomous driving control of the vehicle 2 or assistance in driving the vehicle, the execution information generation unit 31 generates execution information indicating the process.

Upon execution of one of the processes about which execution information is to be generated, the execution information generation unit 31 identifies a road section where the vehicle 2 is, by referring to the high-precision map and the current position of the vehicle 2 indicated by the latest positioning information. In addition, the execution information generation unit 31 determines, for example, the presence or absence of construction, traffic restrictions, or an accident as what indicates the situation around the vehicle 2, by referring to the latest traffic information and the current position of the vehicle 2. The execution information generation unit 31 further identifies weather around the vehicle 2 as what indicates the situation around the vehicle 2, by referring to the latest weather information and the current position of the vehicle. The execution information generation unit 31 then includes information indicating the executed process, such as an identification number of the executed process, and information indicating a road section traveled by the vehicle 2 and the situation around the vehicle 2 at execution of the process, in the execution information. The execution information is generated in this way.

Additionally, the execution information generation unit 31 may identify the situation around the vehicle 2 from images obtained by the camera 11. For example, the execution information generation unit 31 may detect other vehicles traveling in an area around the vehicle 2 (hereafter referred to as “target vehicles” for the sake of convenience) from each of time-series images obtained by the camera 11, and determine whether traffic around the vehicle 2 is congested, based on the detected target vehicles. In this case, the execution information generation unit 31 detects target vehicles by inputting each of the time-series images into a classifier that has been trained to detect a target vehicle. As such a classifier, the execution information generation unit 31 can use, for example, a “deep neural network (DNN)” having architecture of a convolutional neural network (CNN) type. Alternatively, as such a classifier may be used a DNN having architecture of a self-attention network (SAN) type or a classifier based on a machine learning technique other than a DNN, such as a support vector machine. These classifiers are trained in advance with a large number of training images representing a target vehicle to be detected, in accordance with a predetermined training technique, such as backpropagation. The execution information generation unit 31 applies a predetermined tracking technique, such as KLT tracking, to regions representing target vehicles detected from each image to track the individual target vehicles. The execution information generation unit 31 further estimates the speeds of the individual tracked target vehicles in the most recent predetermined period, and determines that traffic around the vehicle 2 is congested, when average speeds of the individual target vehicles are not greater than a predetermined speed threshold. The execution information generation unit 31 can estimate the speed of a target vehicle of interest, based on the speed of the vehicle 2 and the distance between the vehicle 2 and the target vehicle of interest at the time of generation of each image. The bottom position of a region representing a target vehicle of interest in an image is presumed to correspond to the direction, viewed from the camera 11, to the position where the target vehicle is in contact with the road surface; and the height of the mounted position of the camera 11 is known. Thus the execution information generation unit 31 can estimate the distance between the vehicle 2 and a target vehicle of interest, based on that direction from the camera 11 which corresponds to the bottom position of the region representing the target vehicle of interest in the image and the height of the mounted position of the camera 11. When the vehicle 2 is equipped with a distance sensor, the execution information generation unit 31 may estimate the distance between the vehicle 2 and a target vehicle of interest to be a distance measured by the distance sensor in the direction corresponding to the region representing the target vehicle of interest in the image. Further, the execution information generation unit 31 may obtain a measured value of the speed of the vehicle 2 at the time of generation of each image from a vehicle speed sensor (not illustrated) mounted on the vehicle 2.

The execution information generation unit 31 may determine that construction is carried out in an area around the vehicle 2, when a structure, such as a signboard, indicating that construction is carried out is detected by inputting an image obtained by the camera 11 into a classifier like those described above. Similarly, the execution information generation unit 31 may determine that traffic restrictions are imposed in an area around the vehicle 2, when a structure indicating traffic restrictions is detected by inputting an image obtained by the camera 11 into a classifier like those described above.

In this way, the execution information generation unit 31 may include information indicating the situation around the vehicle 2 identified on the basis of an image obtained by the camera 11, in the execution information.

The execution information generation unit 31 transmits the generated execution information to the server 3 via the communication interface 21 and the wireless communication terminal 13.

The determination unit 32 determines a road section where the vehicle 2 is or the situation around the vehicle 2 according to an image generated by the camera 11 or the current position of the vehicle 2 indicated by the latest positioning information at predetermined intervals.

For example, similarly to the execution information generation unit 31, the determination unit 32 determines a road section where the vehicle 2 is, by referring to the high-precision map and the current position of the vehicle 2 indicated by the latest positioning information. In addition, the determination unit 32 determines the presence or absence of construction, traffic restrictions, or an accident, or weather around the vehicle 2 as what indicates the situation around the vehicle 2, by referring to the latest traffic information or weather information and the current position of the vehicle 2.

The determination unit 32 may determine the situation around the vehicle 2, based on an image obtained by the camera 11. In this case, the determination unit 32 executes processing similar to that related to determination of the situation around the vehicle 2 by the execution information generation unit 31 on an image obtained by the camera 11 to determine the situation around the vehicle 2.

The determination unit 32 notifies the priority determination unit 33 of the road section where the vehicle 2 is and the situation around the vehicle 2.

In the case where the priority determination unit 33 determines degrees of priority of the processes, based on either the road section where the vehicle 2 is or the situation around the vehicle 2, as will be described below, the determination unit 32 may also determine only the road section or the situation. In this case, the determination unit 32 may notify only the road section where the vehicle 2 is or the situation around the vehicle 2 to the priority determination unit 33.

The priority determination unit 33 refers to a priority table read from the memory 22 whenever notified of the road section where the vehicle 2 is and the situation around the vehicle 2 by the determination unit 32. The priority determination unit 33 then determines degrees of priority of the processes, depending on the road section where the vehicle 2 is or the situation around the vehicle 2.

The priority table defines degrees of priority of the processes for each combination of individual road sections represented in the high-precision map and possible situations around the vehicle 2. Thus the priority determination unit 33 determines those degrees of priority of the processes which correspond to a combination of the road section where the vehicle 2 is and the situation around the vehicle 2 notified by the determination unit 32, by referring to the priority table.

The priority determination unit 33 may determine degrees of priority of the processes, based on either the road section where the vehicle 2 is or the situation around the vehicle 2. In this case, the priority table may also define degrees of priority of the processes for each road section represented in the high-precision map or for each possible situation around the vehicle 2.

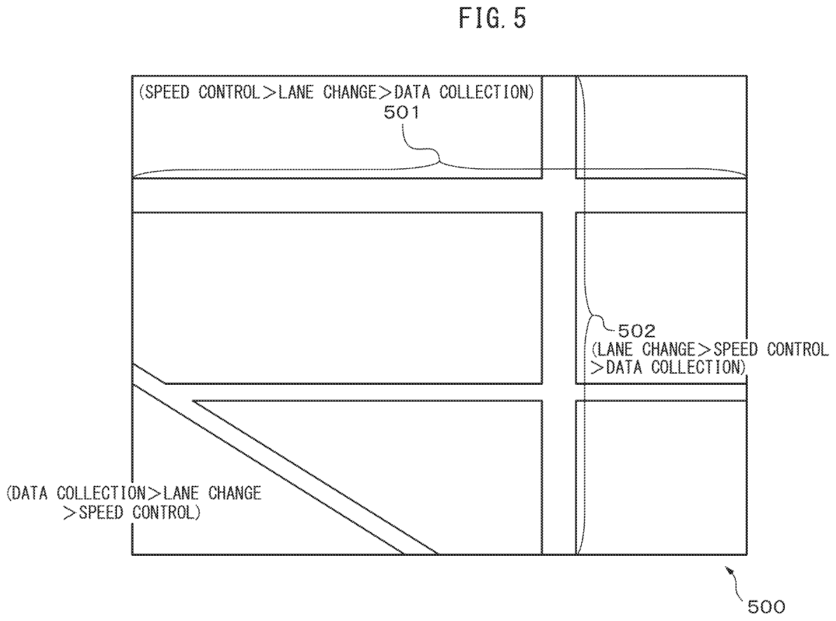

FIG. 5 is a schematic diagram for explaining determination of degrees of priority of processes related to automatically driving or assisting in driving the vehicle 2. In this example, assume that degrees of priority of the processes are determined on the basis of the road section where the vehicle 2 is, and that the processes include a lane change-related process, a speed control-related process, and a data collection-related process.

In a road section 501 in a region 500 illustrated in FIG. 5, the speed control-related process is assigned the highest priority, the lane change-related process the second highest priority, and the data collection-related process the lowest priority, in the priority table. Hence, when the vehicle 2 is traveling on the road section 501, the determined order of priority is the speed control-related process, the lane change-related process, and the data collection-related process.

In a road section 502, the lane change-related process is assigned the highest priority, the speed control-related process the second highest priority, and the data collection-related process the lowest priority, in the priority table. Hence, when the vehicle 2 is traveling on the road section 502, the determined order of priority is the lane change-related process, the speed control-related process, and the data collection-related process.

In road sections other than the road sections 501 and 502, the data collection-related process is assigned the highest priority, the lane change-related process the second highest priority, and the speed control-related process the lowest priority, in the priority table. Hence, when the vehicle 2 is traveling on a road section other than the road sections 501 and 502, the determined order of priority is the data collection-related process, the lane change-related process, and the speed control-related process.

Every time degrees of priority of the processes are determined, the priority determination unit 33 notifies the process control unit 34 of the determined degrees of priority of the processes.

The process control unit 34, which is an example of the control unit, manages execution of the processes and assigns the shared memory 241 and the operating circuits to the processes, by any of the CPUs included in the processor 24. The process control unit 34 executes the processes sequentially in descending order of priority of the processes, using the shared memory 241. Execution of a process herein may be an attempt at the process, i.e., execution of processing to determine whether to operate components of the vehicle 2, depending on the process, and need not be necessarily reflected in an action of components of the vehicle 2.

For example, assume that the process control unit 34 executes a lane change-related process, a process related to determination of the driver's state, and a process related to collection of data of the surroundings of the vehicle 2, in descending order of priority.

In this case, to execute a lane change-related process first, the process control unit 34 reads time-series images obtained by the camera 11 in the most recent predetermined period from the buffer memory 23 and writes the images in the shared memory 241. The process control unit 34 then detects a vehicle traveling ahead of the vehicle 2 on a lane where the vehicle 2 is traveling (hereafter a “leading vehicle”) and a vehicle traveling on an adjoining lane (hereafter an “adjacent lane vehicle”) in the time-series images with a particular operating circuit of the processor 24, such as the GPU. Further, the process control unit 34 tracks the leading vehicle and the adjacent lane vehicle detected in the time-series images, and thereby estimates the speeds of the leading vehicle and the adjacent lane vehicle. Further, the process control unit 34 predicts future positions of the adjacent lane vehicle on the assumption that the adjacent lane vehicle will travel at the estimated speed. The process control unit 34 may execute processing similar to that related to tracking target vehicles by the execution information generation unit 31 to track the leading vehicle and the adjacent lane vehicle and to estimate the speeds of the leading vehicle and the adjacent lane vehicle. The process control unit 34 can also detect lane-dividing lines from each of the time-series images by training the classifier used for detecting vehicles represented in an image so as to detect lane-dividing lines too. Based on the detected lane-dividing lines, the process control unit 34 identifies regions representing the lane of the vehicle 2 and an adjoining lane in each image. The process control unit 34 then determines a vehicle detected on the region representing the lane of the vehicle 2 as a leading vehicle and a vehicle detected on the region representing the adjoining lane as an adjacent lane vehicle. When the speed of the leading vehicle is less than a predetermined speed threshold and the adjoining lane has a space that the vehicle 2 can enter, the process control unit 34 suggests a lane change to the driver via a user interface. When approval for the lane change is obtained via a user interface, the process control unit 34 controls components of the vehicle 2, using one of the CPUs of the processor 24, to change the lane of the vehicle 2. The predetermined speed threshold is set, for example, at a speed less than a speed set for the vehicle 2 or the legally permitted speed of a road section being traveled by the vehicle 2 by a predetermined offset value. When the speed of the leading vehicle is not less than the predetermined speed threshold or when the adjoining lane does not have space sufficient for the vehicle 2 to enter, the process control unit 34 does not change the lane of the vehicle 2.

Upon termination of the lane change-related process, the process control unit 34 reads time-series driver monitor images obtained by the driver monitoring camera (not illustrated) in the most recent predetermined period from the buffer memory 23, to execute a process related to determination of the driver's state. The process control unit 34 then writes the time-series driver monitor images in the shared memory 241.

The process control unit 34 detects the orientation of the driver's face represented in the time-series driver monitor images with a particular operating circuit of the processor 24, such as the GPU, to determine the driver's state. For example, the process control unit 34 detects a face region representing the driver's face from each of the time-series driver monitor images by inputting each driver monitor image into a classifier that has been trained to detect a face. As such a classifier is used, for example, a DNN having architecture of a CNN or SAN type, or an AdaBoost classifier. The process control unit 34 further detects feature points on the driver's face by applying a corner detection filter or template matching to the face region in each driver monitor image. For each driver monitor image, the process control unit 34 then fits the detected feature points to a three-dimensional face model, while variously changing the orientation of the three-dimensional model, and identifies the orientation of the three-dimensional model that the feature points fit best. The process control unit 34 detects the identified orientation of the three-dimensional model as the orientation of the driver's face. Based on the orientation of the driver's face detected from each driver monitor image, the process control unit 34 determines whether the driver is looking away from an area ahead of the vehicle 2. For example, the process control unit 34 determines that the driver is looking away, when the detected face orientation has been outside a tolerable range of the face orientation corresponding to an area ahead of the vehicle 2 for a certain period or more. Further, the process control unit 34 determines that the driver's condition is unusual, when the detected face orientation has been within a range of the face orientation corresponding to a face turned downward for a certain period or more. Further, the process control unit 34 detects regions representing the driver's eyes by applying template matching to the face region in each driver monitor image, and determines time-varying changes in the aspect ratio of the regions representing the eyes. The process control unit 34 may then estimate the level of wakefulness of the driver, based on the time-varying changes in the aspect ratio of the regions representing the eyes.

The process control unit 34 executes a process such as warning to the driver via a user interface (not illustrated) or emergency stop control of the vehicle 2, depending on the result of determination of looking away and the level of wakefulness.

Upon termination of the process related to determination of the driver's state, the process control unit 34 reads time-series images obtained by the camera 11 in the most recent predetermined period from the buffer memory 23, and writes the images in the shared memory 241, to execute a process related to collection of data of the surroundings of the vehicle 2. The process control unit 34 then detects predetermined features around the vehicle 2 (e.g., road markings such as lane-dividing lines or stop lines, curbstones, and predetermined signboards such as signposts) from the time-series images with a particular operating circuit of the processor 24, such as the GPU. The process control unit 34 detects the predetermined features from each of the time-series images by inputting each image into a classifier that has been trained to detect the predetermined features. As such a classifier, the process control unit 34 can use a DNN having architecture of a CNN or SAN type. In addition, the process control unit 34 estimates the positions of the detected individual features in accordance with the technique of structure from motion (SfM). To this end, the process control unit 34 uses the position and orientation of the vehicle 2 at the time of generation of each image estimated from positioning information and odometry information, the height of the mounted position, the orientation, and the focal length of the camera 11, and the regions in each image representing the detected individual features for estimating the positions of the individual features. The process control unit 34 then generates probe data indicating the types and positions of the detected individual features, and transmits the generated probe data to another device via the wireless communication terminal 13.

In this way, the process control unit 34 executes multiple processes in descending order of priority, using the shared memory 241. As for a process that does not use the shared memory 241 among the processes, the process control unit 34 may execute the process in parallel with another process regardless of the priority thereof. When there is a process actually reflected in an action of the vehicle 2, the process control unit 34 notifies the execution information generation unit 31 of execution of the process. For example, in the case where the vehicle 2 has executed the lane change-related process and thereby actually made a lane change, the process control unit 34 notifies the execution information generation unit 31 of execution of the lane change-related process. In the case where the vehicle 2 has executed the lane change-related process but has not actually made a lane change, the process control unit 34 does not notify the execution information generation unit 31 of execution of the lane change-related process.

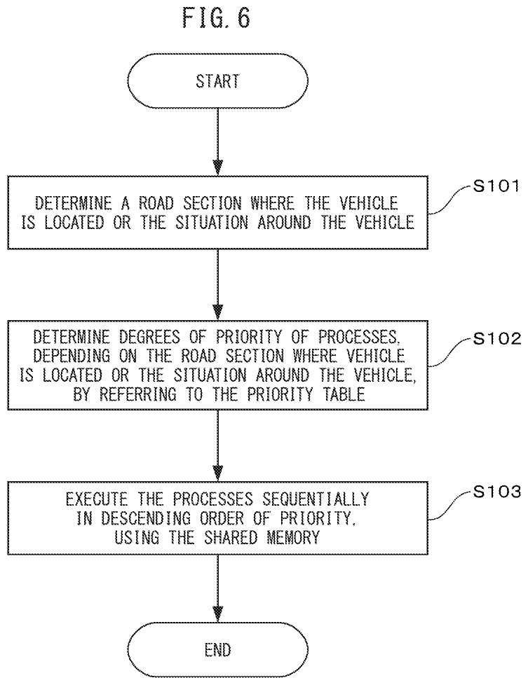

FIG. 6 is an operation flowchart of the vehicle control process executed by the processor 24. The processor 24 executes the vehicle control process in accordance with the operation flowchart described below at predetermined intervals.

The determination unit 32 of the processor 24 determines a road section where the vehicle 2 is or the situation around the vehicle 2 according to an image generated by the camera 11 or the current position of the vehicle 2 indicated by the latest positioning information (step S101). Next, the priority determination unit 33 of the processor 24 determines degrees of priority of processes related to automatically driving or assisting in driving the vehicle 2, depending on the road section where the vehicle 2 is or the situation around the vehicle 2, by referring to the priority table (step S102). The process control unit 34 of the processor 24 then executes the processes sequentially in descending order of priority of the processes, using the shared memory 241 (step S103). Thereafter, the processor 24 terminates the vehicle control process.

As has been described above, the vehicle controller refers to the priority table representing degrees of priority of processes related to automatically driving or assisting in driving the vehicle for each road section or for each possible situation around the vehicle. The vehicle controller then determines degrees of priority of the processes, depending on a road section where the vehicle is or the situation around the vehicle, and executes the processes sequentially in descending order of priority, using a shared resource. Thus the vehicle controller can execute a process having high priority in a road section where the vehicle is or the situation around the vehicle promptly.

The shared resource is not limited to the shared memory. For example, when each of the processes is executed using a particular operating circuit included in the processor 24 (e.g., the GPU), the particular operating circuit is also an example of the shared resource.

The following describes the server 3, which is an example of the priority setting device.

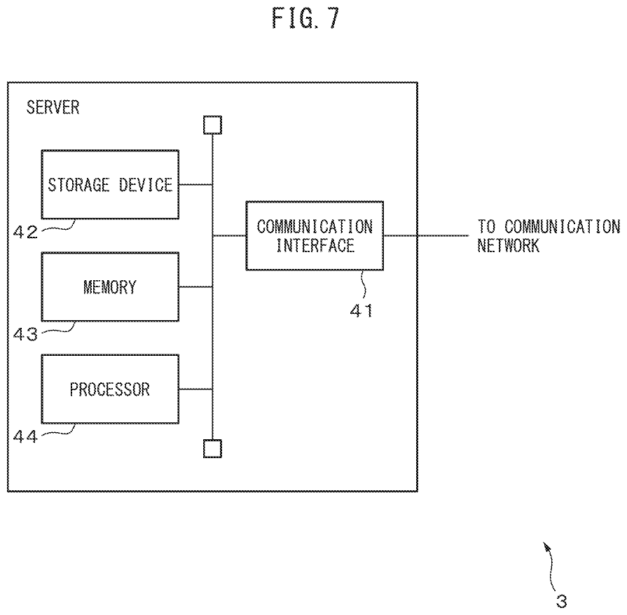

FIG. 7 illustrates the hardware configuration of the server 3. The server 3 includes a communication interface 41, a storage device 42, a memory 43, and a processor 44. The communication interface 41, the storage device 42, and the memory 43 are connected to the processor 44 via a signal line. The server 3 may further include an input device, such as a keyboard and a mouse, and a display device, such as a liquid crystal display.

The communication interface 41, which is an example of the communication unit, includes an interface circuit for connecting the server 3 to the communication network 4. The communication interface 41 is configured to be communicable with the vehicle 2 via the communication network 4 and the wireless base station 5. More specifically, the communication interface 41 passes execution information received from the vehicle 2 via the wireless base station 5 and the communication network 4 to the processor 44. In addition, the communication interface 41 transmits the priority table received from the processor 44 to the vehicle 2 via the communication network 4 and the wireless base station 5.

The storage device 42, which is an example of the storage unit, includes, for example, a hard disk drive, or an optical medium and an access device therefor. The storage device 42 stores various types of data and information used in a priority setting process. For example, the storage device 42 stores map information used for identifying individual road sections, individual pieces of execution information received from the vehicle 2, and identifying information of the vehicle 2. The storage device 42 may further store a computer program for the priority setting process executed by the processor 44.

The memory 43, which is another example of the storage unit, includes, for example, nonvolatile and volatile semiconductor memories. The memory 43 temporarily stores various types of data generated during execution of the priority setting process.

The processor 44 includes one or more central processing units (CPUs) and a peripheral circuit thereof. The processor 44 may further include another operating circuit, such as a logic-arithmetic unit or an arithmetic unit. The processor 44 executes the priority setting process.

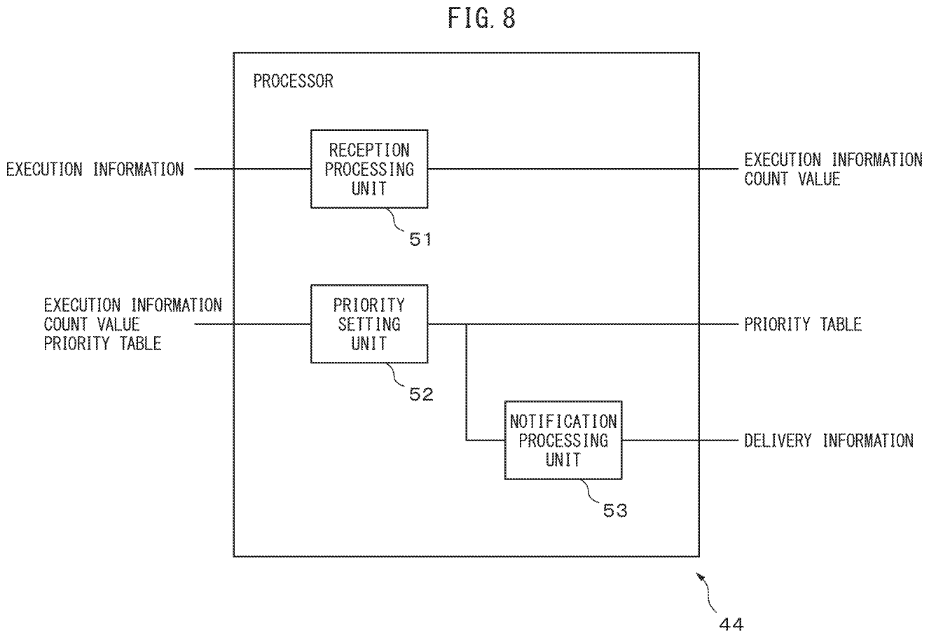

FIG. 8 is a functional block diagram of the processor 44, related to the priority setting process. The processor 44 includes a reception processing unit 51, a priority setting unit 52, and a notification processing unit 53. These units included in the processor 44 are functional modules, for example, implemented by a computer program executed by the processor 44, or may be dedicated operating circuits provided in the processor 44.

Every time execution information is received from the vehicle 2 via the communication network 4 and the communication interface 41, the reception processing unit 51 stores the received execution information in the storage device 42. At this storing, the reception processing unit 51 increments, by one, a count value indicating the number of pieces of execution information for a combination of the road section where the vehicle 2 was and the situation around the vehicle 2 at generation of the execution information; the road section and the situation are indicated by the execution information. When the priority table is made so as to represent degrees of priority of the processes for each road section, the reception processing unit 51 increments, by one, a count value indicating the number of pieces of execution information for the road section where the vehicle 2 was at generation of the execution information. When the priority table is made so as to represent degrees of priority of the processes for each possible situation around the vehicle 2, the reception processing unit 51 increments, by one, a count value indicating the number of pieces of execution information for the situation around the vehicle 2 at generation of the execution information.

The priority setting unit 52 sets degrees of priority of the processes for a combination of the road section and the situation around the vehicle whose count value indicating the number of received pieces of execution information is not less than a predetermined number. To achieve this, the priority setting unit 52 reads each piece of execution information corresponding to a combination of the road section and the situation around the vehicle whose count value is not less than the predetermined number, from the storage device 42. By referring to the read individual pieces of execution information indicating processes executed at the vehicle 2, the priority setting unit 52 counts, for each process, the number of times of execution of the process at the vehicle 2. The priority setting unit 52 sets degrees of priority of the processes so that a process executed a larger number of times at the vehicle 2 has higher priority. For example, assume that the numbers of times of execution of the lane change-related process, the speed control-related process, and the process related to determination of the driver's state are 100, 120, and 80, respectively. In this case, the priority setting unit 52 assigns the highest priority to the speed control-related process, the second highest priority to the lane change-related process, and the lowest priority to the process related to determination of the driver's state.

When the priority table is made so as to represent degrees of priority of the processes for each road section, the priority setting unit 52 sets degrees of priority of the processes for each road section whose count value indicating the number of received pieces of execution information is not less than the predetermined number. To achieve this, the priority setting unit 52 reads each piece of execution information corresponding to a road section whose count value is not less than the predetermined number from the storage device 42, and executes processing similar to that described above on the read individual pieces of execution information. When the priority table is made so as to represent degrees of priority of the processes for each possible situation around the vehicle 2, the priority setting unit 52 sets degrees of priority of the processes for each situation around the vehicle 2 whose count value indicating the number of received pieces of execution information is not less than the predetermined number. To achieve this, the priority setting unit 52 reads each piece of execution information corresponding to a situation around the vehicle 2 whose count value is not less than the predetermined number from the storage device 42, and executes processing similar to that described above on the read individual pieces of execution information.

The priority setting unit 52 updates the priority table so as to reflect the set individual degrees of priority of the processes, and stores the updated priority table in the storage device 42 and passes the table to the notification processing unit 53.

Upon receiving the updated priority table, the notification processing unit 53 generates delivery information including the received priority table, and transmits the generated delivery information to the vehicle 2 via the communication interface 41 and the communication network 4, by referring to identifying information of the vehicle 2. In this way, the vehicle 2 can use the updated priority table.

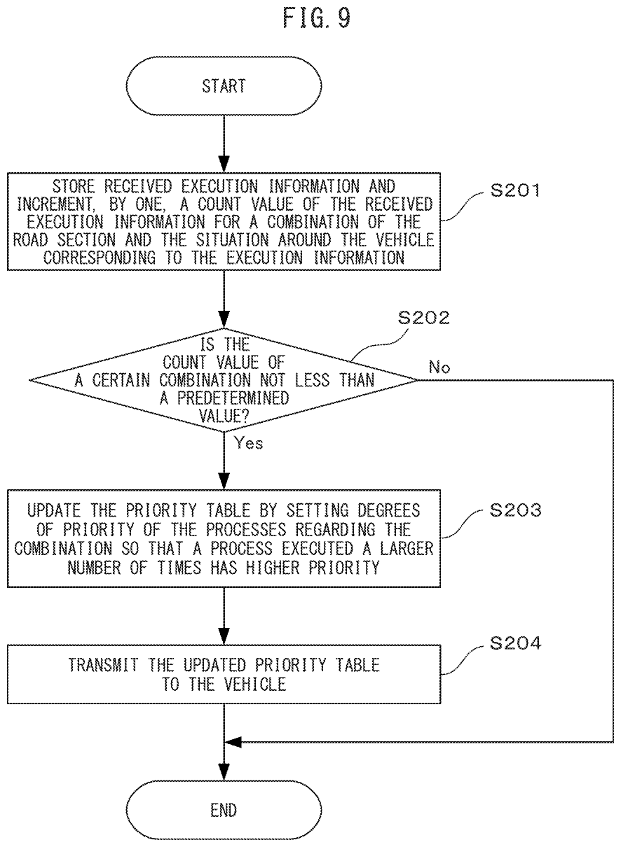

FIG. 9 is an operation flowchart of the priority setting process. Upon receiving execution information from the vehicle 2, the reception processing unit 51 of the processor 44 stores the received execution information in the storage device 42. The reception processing unit 51 further increments, by one, a count value indicating the number of received pieces of execution information for a combination of the road section and the situation around the vehicle 2 corresponding to the execution information (step S201).

The priority setting unit 52 of the processor 44 determines whether the count value of one of combinations of road sections and possible situations around the vehicle 2 is not less than a predetermined number (step S202). When the count value of every combination is less than the predetermined number (No in step S202), the processor 44 terminates the priority setting process. When the count value of a certain combination is not less than the predetermined number (Yes in step S202), the priority setting unit 52 reads individual pieces of execution information corresponding to the combination from the storage device 42. The priority setting unit 52 then updates the priority table by setting degrees of priority of the processes, based on the read individual pieces of execution information, so that a process executed a larger number of times has higher priority (step S203). Thereafter, the notification processing unit 53 of the processor 44 transmits the updated priority table to the vehicle 2 via the communication interface 41 and the communication network 4 (step S204). The processor 44 then terminates the priority setting process.

As has been described above, the vehicle controller sets degrees of priority of processes related to automatically driving or assisting in driving the vehicle for each road section or for each possible situation around the vehicle, so that a process executed a larger number of times has higher priority. This enables the vehicle controller to set degrees of priority of the processes appropriately for each road section or for each possible situation around the vehicle.

The degrees of priority of the processes for each road section or for each possible situation around the vehicle may be set in advance. For example, the degrees of priority of the processes may be set for each road section or for each possible situation around the vehicle, based on the viewpoint of safety of the vehicle or the driver's convenience. In particular, a process related to safety of the vehicle may be assigned higher priority than the other processes regardless of the road section and the possible situation around the vehicle. According to the assigned degrees of priority of the processes, the priority table may be made for each road section or for each possible situation around the vehicle. In this case, the priority table may be stored in the storage device 14 of the vehicle 2 together with the high-precision map, for example, before shipment from the factory. In this case, since the priority setting process need not be executed, the server 3 and the processing by the execution information generation unit 31 of the ECU 15 of the vehicle 2 may be omitted.

As described above, those skilled in the art may make various modifications according to embodiments within the scope of the present invention.

What is claimed is:

1. A vehicle controller comprising:
a memory configured to store a priority table representing degrees of priority of a plurality of processes related to automatically driving or assisting in driving a vehicle for each road section or for each possible situation around the vehicle; and
a processor configured to:
determine a road section where the vehicle is or the situation around the vehicle according to the position of the vehicle or a sensor signal generated by a sensor mounted on the vehicle for detecting the situation around the vehicle,
determine degrees of priority of the processes, depending on the road section where the vehicle is or the situation around the vehicle, by referring to the priority table, and
execute the processes sequentially in descending order of priority of the processes, using a shared resource.

2. A method for vehicle control, comprising:
determining a road section where a vehicle is or the situation around the vehicle according to the position of the vehicle or a sensor signal generated by a sensor mounted on the vehicle for detecting the situation around the vehicle;
determining degrees of priority of a plurality of processes related to automatically driving or assisting in driving the vehicle, depending on the road section where the vehicle is or the situation around the vehicle, by referring to a priority table representing degrees of priority of the processes for each road section or for each possible situation around the vehicle; and
executing the processes sequentially in descending order of priority of the processes, using a shared resource.

3. A non-transitory recording medium that stores a computer program for vehicle control, the computer program causing a processor mounted on a vehicle to execute a process comprising:
determining a road section where the vehicle is or the situation around the vehicle according to the position of the vehicle or a sensor signal generated by a sensor mounted on the vehicle for detecting the situation around the vehicle;
determining degrees of priority of a plurality of processes related to automatically driving or assisting in driving the vehicle, depending on the road section where the vehicle is or the situation around the vehicle, by referring to a priority table representing degrees of priority of the processes for each road section or for each possible situation around the vehicle; and
executing the processes sequentially in descending order of priority of the processes, using a shared resource.

4. A priority setting device comprising:
a memory; and
a processor configured to:
store, every time execution information is received from at least one vehicle via a communication module, the execution information in the memory, the execution information indicating a road section traveled by the vehicle or the situation around the vehicle at execution of a process among a plurality of processes related to automatically driving or assisting in driving the vehicle as well as the executed process,
set degrees of priority of the processes for each road section or for each possible situation around the vehicle, based on pieces of execution information stored in the memory, so that a process executed a larger number of times has higher priority among the processes, and
notify the vehicle via the communication module of a priority table representing degrees of priority of the processes for each road section or for each possible situation around the vehicle.

5. A vehicle control system comprising:
at least one vehicle; and
a priority setting device capable of communicating with the at least one vehicle, wherein
each of the at least one vehicle comprising:
a memory configured to store a priority table representing degrees of priority of a plurality of processes related to automatically driving or assisting in driving the vehicle for each road section or for each possible situation around the vehicle; and
a processor configured to:
determine a road section where the vehicle is or the situation around the vehicle according to the position of the vehicle or a sensor signal generated by a sensor mounted on the vehicle for detecting the situation around the vehicle,
determine degrees of priority of the processes, depending on the road section where the vehicle is or the situation around the vehicle, by referring to the priority table,
execute the processes sequentially in descending order of priority of the processes, using a shared resource,
generate execution information indicating a process actually reflected in an action of the vehicle among the processes as well as the road section where the vehicle is or the situation around the vehicle, and
transmit the generated execution information to the priority setting device via a communication device, and wherein
the priority setting device comprising:
a memory; and
a processor configured to:
store, every time the execution information is received from one of the at least one vehicle via a communication module, the execution information in the memory of the priority setting device,
set degrees of priority of the processes for each road section or for each possible situation around the vehicle, based on pieces of execution information stored in the memory of the priority setting device, so that a process executed a larger number of times has higher priority among the processes, and
notify each of the at least one vehicle via the communication module of the priority table representing degrees of priority of the processes for each road section or for each possible situation around the vehicle.
